(19) United States
(12) Patent Application Publication
(10) Pub. No.: US 2025/0351939 A1
(43) Pub. Date: Nov. 20, 2025

(54) PORTABLE ITEM CAPABLE OF SELECTIVE SMART CONTROL OF FRAGRANCE CAPSULE

(71) Applicants: Seong Kyu LIM, Daegu (KR); Jong Yoon LIM, Daegu (KR)

(72) Inventors: Seong Kyu LIM, Daegu (KR); Jong Yoon LIM, Daegu (KR)

(21) Appl. No.: 18/868,691

(22) PCT Filed: May 22, 2023
(86) PCT No.: PCT/KR2023/006917

§ 371 Date: Nov. 22, 2024

(30) Foreign Application Priority Data
May 23, 2022 (KR) 10-2022-0063085

(51) Int. Cl. A45D 34/02; B05B 12/00; B05B 12/02

(52) U.S. Cl. CPC A45D 34/02; B05B 12/002; B05B 12/02; A45D 2200/054

(57) ABSTRACT

The present invention relates to a portable item capable of selective smart control of a fragrance capsule that provides the fragrance capsule, together with a mechanical structure, to allow the fragrance in the fragrance capsule to be selectively emitted using a smartphone always carried by a user. The portable item capable of selective smart control of a fragrance capsule is configured to allow two or more fragrance capsule parts containing fragrances to be inserted into the inside or outside thereof, thereby emitting the fragrances of the capsule parts individually or together, and configured to allow such control to be performed through a smartphone, thereby providing conveniences of use thereof, and configured to provide a structure into which the capsule parts are inserted, thereby allowing the selective smart control of the capsule parts to be performed according to use situations and purposes thereof.

### TECHNICAL FIELD

The present invention relates to a portable item capable of selective smart control of a fragrance capsule, more specifically to a portable item capable of selective smart control of a fragrance capsule that provides the fragrance capsule, together with a mechanical structure, to allow the fragrance in the fragrance capsule to be selectively emitted using a smartphone always carried by a user.

### BACKGROUND ART

Generally, an ornament is used for the adornment of the human body rather than used for a specific function so that it is carried by a wearer or hangs on his or her portable item by means of a loop.

Ornaments are used for the adornment of bodies of women or for the expression of their uniqueness, but for the expression of uniqueness of men like women, recently, various ornaments have been also used.

As ornaments worn on the body, representatively, there are necklaces, bracelets, ankle bracelets, earrings, and the like, and further, there are pierced ornaments fixed to various regions of the body.

Furthermore, the ornaments commonly hang on portable items such as clothes, smartphones, and the like as well as the body.

Besides, the ornaments simply have the act of decorating something or someone through their shape, and they are made of precious metals such as gold, platinum, silver, and the like, germanium, or jade.

A conventional fragrance ornament as disclosed in Korean Utility Model Registration No. 0294266 (Oct. 24, 2002) has the shape of a bracelet or necklace worn on a human body's wrist or pet's neck, which has an aroma built therein to emit natural fragrance, and further, an antibacterial material is additionally contained in the aroma for the ornament for the pet, which protects the pet from harmful insects.

However, the conventional ornaments just have an adornment function and given functions obtained by the materials harmful to the human body, and as a worldwide pandemic has recently passed, it is considered that individual hygiene is important more than ever, so that hand washing as well as social distancing is emphasized. In this case, even though a person touches an item touched by a lot of people, his or her hands are washed with a hand sanitizer having a sterilization function, and otherwise, his or her touch is prevented. However, it is very inconvenient that the hand sanitizer is carried by an individual, and he or she has to touch an item necessarily requiring touch such as button control, which causes insanitary problems.

Further, a portable item, which is provided to allow an object to be easily carried, includes a portable item body having an object-receiving space portion formed therein and a brace or handle attached to the portable item body.

Furthermore, the portable item body consists of an outer cover forming the outer surface thereof and a water-proof fabric applied to the inner surface of the outer cover to prevent a liquid including water from permeating into the object-receiving space portion.

According to Korean Patent Application Laid-open No. 20-1994-0018843, there is disclosed a portable air freshener that allows micro capsules made by forming a particular adhesion material on particles of a fragrance separated to extremely fine structures in the form of a film and curing the adhesion material to be coated onto an appropriate portion of the top or underside of an existing portable item.

According to Korean Patent Registration No. 20-0182805, there is disclosed a portable item having a fragrance-emitting function that includes a portable item body having an object-receiving space portion formed therein and a brace coupled to the portable item body, wherein the portable item body and a body contact portion of the brace have an adhesion liquid with which micro capsules are mixed and each micro capsule has a raw fabric with the fragrance-emitting function.

According to Korean Patent Registration No. 20-0298141, there is disclosed a portable item handle that is made of a synthetic resin or wood and molded into a mold to have a handle part and a portable item-connecting and fixing part by means of injection or machining, wherein the molded portable item handle is submerged into a fragrance-receiving liquid for a given period of time and thus emits a fragrance therefrom.

The conventional arts relate to the technologies of emitting fragrances to the portable items and to the fragrance chips detachably attached to the portable items. However, the conventional arts can emit only fragrances, and they have no fragrances specifically designed to repel insects such as mosquitoes.

### DISCLOSURE

### Technical Problem

Accordingly, the present invention has been made in view of the above-mentioned problems occurring in the related art, and it is an object of the present invention to provide a portable item capable of selective smart control of a fragrance capsule that is configured to allow two or more capsule parts containing fragrances to be inserted into the inside or outside thereof, thereby emitting the fragrances of the capsule parts individually or together, and configured to allow such control to be performed through a smartphone, thereby providing conveniences of use thereof, and configured to provide a structure into which the capsule parts are inserted, thereby allowing the selective smart control of the capsule parts to be performed according to use situations and purposes thereof.

### Technical Solution

To accomplish the above-mentioned objects, according to the present invention, there is provided a portable item capable of emitting fragrance, including: a fragrance capsule having a body part having a slide portion formed on an outer side thereof in such a way as to be slidably coupled to a slide hole formed on one side of the portable item and a capsule insertion groove formed on the central portion of top thereof in such a way as to have a predetermined depth in a downward direction, a capsule part containing a liquid having one or more fragrances therein and fitted to the capsule insertion groove, a pressing part inserted into the capsule insertion groove and positioned above the capsule part in such a way as to press one side of the capsule part, a control part for controlling the pressing part selectively or periodically at predetermined time intervals, a battery part for supplying power to the control part, and a communication means for communicating with a smartphone; and the smartphone in which an application for selectively controlling the control part is installed.

### Advantageous Effects

According to the embodiment of the present invention, the portable item capable of selective smart control of the fragrance capsule can have the inherent purpose of emitting the fragrance, allow for easy replacement of the fragrance capsule through the selectively attachable and detachable structure formed on one side thereof, and selectively control emission of fragrance from the fragrance capsule using the smartphone, thereby providing conveniences of use thereof.

### DESCRIPTION OF DRAWINGS

FIG. 1 is an enlarged perspective view illustrating a portable item capable of selective smart control of a fragrance capsule according to a preferred embodiment of the present invention.

FIG. 2 is a perspective view illustrating the fragrance capsule of the portable item according to the preferred embodiment of the present invention.

FIG. 3 is an exploded perspective view illustrating the fragrance capsule of the portable item according to the preferred embodiment of the present invention.

FIG. 4 is a sectional view illustrating the fragrance capsule of the portable item according to the preferred embodiment of the present invention.

FIG. 5 is a sectional view illustrating a use state of the fragrance capsule of the portable item according to the preferred embodiment of the present invention.

FIG. 6 is a perspective view illustrating the control of the fragrance capsule of the portable item using a smartphone according to the preferred embodiment of the present invention.

FIG. 7 is a side view illustrating a portable item capable of selective smart control of a plurality of capsule parts according to another embodiment of the present invention.

### MODE FOR INVENTION

The present invention relates to a portable item capable of selective smart control of a fragrance capsule that provides the fragrance capsule, together with a mechanical structure, to allow the fragrance in the fragrance capsule to be selectively emitted using a smartphone always carried by a user.

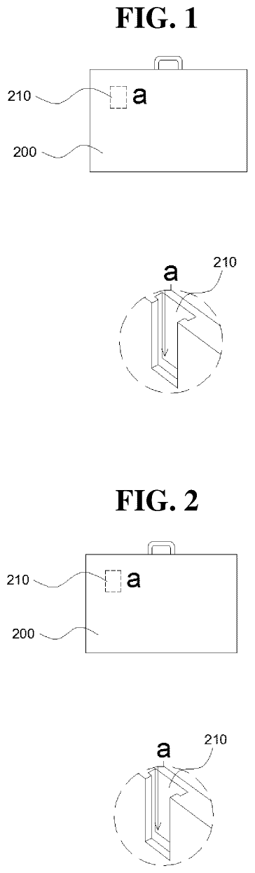

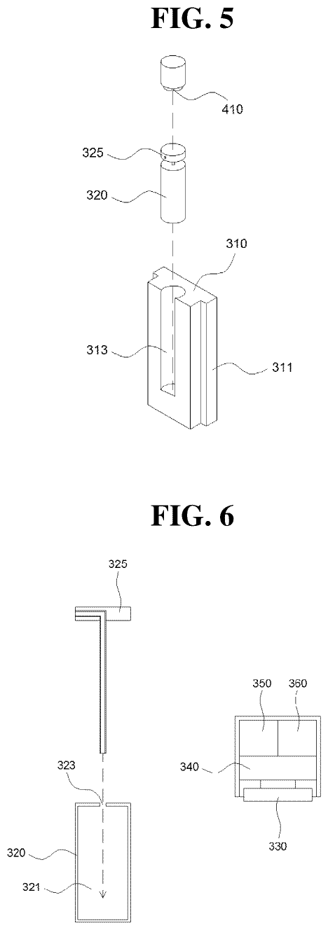

Hereinafter, an explanation on a desirable configuration and operations of a portable item capable of selective smart control of a fragrance capsule according to the present invention will be given in detail with reference to FIGS. 1 to 7.

Referring first to the configuration of the present invention, a portable item 200 capable of emitting fragrance includes: a fragrance capsule 300 having a body part 310 having a slide portion 311 formed at an outer side thereof in such a way as to be slidably coupled to a slide hole 210 formed on one side of the portable item 200 and a capsule insertion groove 313 formed on the central portion of top thereof in such a way as to have a predetermined depth in a downward direction, a capsule part 320 containing a liquid having one or more fragrances therein and fitted to the capsule insertion groove 313, a pressing part 330 inserted into the capsule insertion groove 313 and positioned above the fragrance capsule 300 in such a way as to press one side of the capsule part 320, a control part 340 for controlling the pressing part 330 selectively or periodically at predetermined time intervals, a battery part 350 for supplying power to the control part 340, and a communication means 360 for communicating with a smartphone 400; and the smartphone 400 in which an application for selectively controlling the control part 340 is installed.

That is, the liquid containing fragrances, which is located inside the capsule part 320, is discharged to the outside using the smartphone 400 always carried by a user and the control module 400 located in the portable item 200.

In this case, the fragrances may include various scents, and if necessary, they may include scents that can repel insects such as mosquitoes, flies, and the like.

The portable item 200 according to the present invention is provided with the capsule part 320, but the capsule part 320 may be an ornament worn on any one of the wrist, ankle, finger, neck, hair, eyelash, and artificial nail or a bag in which items are stored and carried.

As shown in FIG. 1, the portable item 200 includes the slide hole 210 formed at one side of an upper portion thereof in such a way as to have a predetermined depth in a vertical direction. The slide hole 210 has the shape of “T” when viewed from the plane in such a way as to correspond to the external appearance of the slide portion 311, so that the slide portion 311 is fitted vertically to the slide hole 210 and thus prevented from escaping in a horizontal direction.

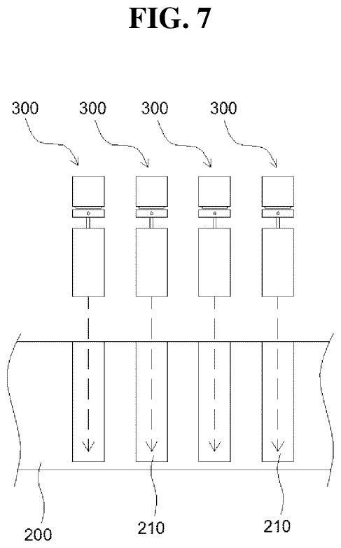

As shown in FIG. 7, the slide hole 210 may have two or more protrusions protruding from both sides thereof, thereby ensuring a more robust fixing force to the slide portion 311.

Further, the slide hole 210 is located inside or outside the portable item 200 in such a way as to have the shape of the above-mentioned “T”, a circle, or a pocket.

Furthermore, the fragrance capsule 300 inserted into the slide hole 210 has the same outer shape as the slide hole 210.

Referring to FIGS. 2 to 5, a configuration of the fragrance capsule 300 will be described, and first, the fragrance capsule 300 includes the body part 310 and the capsule part 320.

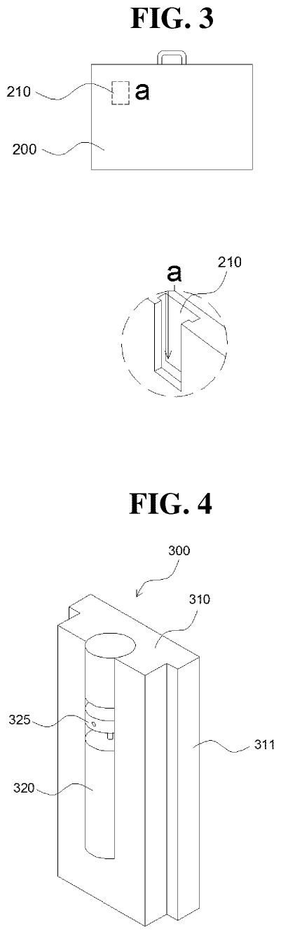

As shown in FIG. 2 or 3, the body part 310 has the slide portion 311 slidingly coupled with the slide hole 210, and in this case, the slide portion 311 also has the shape of “T” shape in such a way as to fit into the slide hole 210. Further, the capsule insertion groove 313 is formed in a central portion of top of the body part 310 in such a way as to insert the capsule part 320 as will be discussed later thereinto.

Further, the capsule part 320 is configured to contain the liquid that emits fragrance. In this case, the term “liquid” refers to any liquid that emits fragrance. That is, the liquid may emit various fragrances, such as fragrances that insects dislike, sweet fragrances, and the like.

In this case, as shown in FIG. 3 or 4, the capsule part 320 has flexible properties on the entire portion excepting a portion of top thereof and includes a space portion 321 formed therein in such a way as to fill the liquid fragrance thereinto, a hole 323 formed on a given portion of the top thereof in such a way as to communicate with the space portion 321 to allow the liquid fragrance to be filled into or discharged from the space portion 321, and a sprayer 325 adapted to selectively seal the hole 323 and to be pressed by the pressing part 330 to selectively discharge the liquid fragrance.

That is, the capsule part 320 has the flexible properties so that it can be prevented from being damaged or broken due to impacts or similar causes. The portion of top of the capsule part 320 is preferably made of a relatively hard material so that the sprayer 325 can be kept in a fixed shape if pressed by the pressing part 410.

In the present invention, the capsule part 320 is shown in the drawings, while not being divided into a flexible part and a non-flexible part.

Further, as shown in FIG. 4, the fragrance-containing liquid is sprayed so that the fragrance contained in the liquid can be emitted, as mentioned above, and in this case, the space portion 321 is a space adapted to hold such a liquid.

Additionally, although not illustrated, one space is formed in the space portion 321, and if necessary, a plurality of segmented spaces are formed therein in such a way as to be filled with the same fragrance as one another or different fragrances from one another.

In this case, if the plurality of segmented spaces as the space portion 321 are filled with different fragrances from one another, the different fragrances in the respective spaces are emitted through sprayers 325 as will be discussed later connected individually to the respective spaces, and otherwise, the different fragrances in the respective spaces may be emitted through a single sprayer 325.

The hole 323 serves as a passage adapted to fill the fragrance-containing liquid into the space portion 321 and spray it through the sprayer 325, and in this case, one hole or a plurality of holes may be formed.

As shown in FIG. 4, the sprayer 325 is provided on the non-flexible portion of the top of the capsule part 320 and is configured to spray the fragrance-containing liquid of the space portion 321 with a single press.

In this case, the sprayer 325 has a typical pump structure, and if necessary, it may have a structure that can selectively spray liquid into the outside.

In addition, the number of sprayers 325 corresponds to the number of space portions 321 and the number of holes 323.

For example, if a plurality of space portions 321 are formed to have their respective holes 323, each sprayer 325 is located on top of each hole 323 to spray the liquid contained in any one of the space portions 321 according to the operation of the pressing part 330.

If a plurality of space portions 321 are formed to have a single hole 323 formed on their topmost position thereof, while having their respective holes 323, the sprayer 325 is located only on the single hole 323.

Such a structure allows users to purchase and use a capsule part 320 with a structure that suits their usage purpose and needs.

As a result, the fragrance emitted from the capsule part 320 may be a single fragrance or mixed fragrances, depending on whether the plurality of space portions 321 have the same fragrance-containing liquid as one another or different fragrance-containing liquids from one another.

In the case where the plurality of space portions 321 have different fragrance-containing liquids from one another and a single hole 323 and a single sprayer 325 are provided, the different fragrance-containing liquids in the plurality of space portions 321 are pulled together, at the time when the sprayer 325 is pressed, and then sprayed through the sprayer 325, so that the different fragrances can be mixed.

Additionally, in the case where the sprayer 325 has a plurality of suction parts formed on the spray portion thereof, the fragrance liquids of the respective space portions 321 are not mixed before sprayed through the sprayer 325, but they are mixed after sprayed. In the case where the sprayer 325 has a single spray portion and the number of suction parts corresponding to the number of the space portions 321, fragrances are mixed before sprayed through the sprayer 325, so that the mixed fragrances can be emitted.

To selectively control the capsule part 320, further, the pressing part 330, the control part 340, the battery part 350, and the communication means 360 are substantially fit into the capsule insertion groove 313 in the form of a single module and located above the capsule part 320. That is, the pressing part 330 is positioned to come into contact with the sprayer 325 in such a way as to press the sprayer 325 to allow the fragrance-containing liquid to be sprayed, the control part 340 is located on top of the pressing part 330 in such a way as to receive control commands from the smartphone 400 and control the operation of the pressing part 330, the battery part 350 is located on top of the control part 340 in such a way as to supply power to the control part 340, and the communication means 360 receives signals from the smartphone 400 and thus operates the control part 340.

In this case, as shown in FIGS. 3 to 5, the pressing part 330 has a similar shape to a cylinder and moves in one direction according to the control commands from the control part 340 to press the sprayer 325 coming into close contact therewith, so that the liquid is sprayed through the sprayer 325.

In this case, the pressing part 330 can have a mechanical structure or electromagnetic structure, and after pressed once, desirably, the pressing part 300 is returned to its original state.

The control part 340 typically controls any mechanical the battery part 350 and the or electronic part, and communication means 360 are typical parts. Therefore, detailed explanations of the control part 340, the battery part 350, and the communication means 360 will be omitted.

In this case, the control part 340 can operate the pressing part 330 selectively or periodically for a given period of time, like a timer.

As shown in FIG. 7, two or more slide holes 210 are formed spaced apart from one another on one side of the portable item 200, and two or more capsule parts 320 with the same or different fragrances are provided, so that the spray operations for the capsule parts 320 are controlled individually or together through an application of the smartphone 400.

In this case, a plurality of capsule parts 320 are inserted correspondingly into the slide holes 210, while not having any segmented space portions 321 formed therein, so that the respective capsule parts 320 are selectively controlled by the smartphone 400.

According to the embodiment of the present invention, the portable item capable of selective smart control of the fragrance capsule can have the inherent purpose of emitting the fragrance, allow for easy replacement of the fragrance capsule through the selectively attachable and detachable structure formed on one side thereof, and selectively control emission of fragrance from the fragrance capsule using the smartphone, thereby providing conveniences of use thereof.

1. A portable item capable of emitting fragrance, while being worn on a user's body and carried by the user, the portable item comprising:
a fragrance capsule comprising a body part having a slide portion formed on an outer side thereof in such a way as to be slidably coupled to a slide hole formed on one side of the portable item and a capsule insertion groove formed on the central portion of top thereof in such a way as to have a predetermined depth in a downward direction, a capsule part containing a liquid having one or more fragrances therein and fitted to the capsule insertion groove, a pressing part inserted into the capsule insertion groove and positioned above the capsule part in such a way as to press one side of the capsule part, a control part for controlling the pressing part selectively or periodically at predetermined time intervals, a battery part for supplying power to the control part, and a communication means for communicating with a smartphone; and
the smartphone in which an application for selectively controlling the control part is installed.

2. The portable item according to claim 1, wherein two or more slide holes are formed spaced apart from one another at predetermined intervals on one side of the portable item, and two or more capsule parts containing the same fragrance or different fragrances are provided, so that the fragrances of the capsule parts are sprayed individually or together through the application of the smartphone.

3. The portable item according to claim 1, wherein the capsule part has flexible properties on the entire portion excepting a portion of top thereof and comprises:
a space portion formed therein in such a way as to fill a liquid fragrance thereinto;
a hole formed on a given portion of the top thereof in such a way as to communicate with the space portion to allow the liquid fragrance to be filled into or discharged from the space portion; and
a sprayer adapted to selectively seal the hole and to be pressed by the pressing part to selectively discharge the liquid fragrance.
